(19) United States
(12) Patent Application Publication
(10) Pub. No.: US 2024/0355569 A1
(43) Pub. Date: Oct. 24, 2024

(54) ELECTRICAL ASSEMBLY

(71) Applicant: Siemens Aktiengesellschaft, München (DE)

(72) Inventors: Nils Anger, Berlin (DE); Edouard Desplanche, Berlin (DE); Stephan Welzel, Berlin (DE)

(21) Appl. No.: 18/641,657

(22) Filed: Apr. 22, 2024

(30) Foreign Application Priority Data
Apr. 21, 2023 (DE) 10 2023 203 692.4

(51) Int. Cl. H01H 71/10; H01H 31/00; H01H 71/02; H01H 73/04

(52) U.S. Cl. CPC H01H 71/1009; H01H 31/003; H01H 73/04; H01H 2071/0285

(57) ABSTRACT

An electrical assembly has an isolator function, a circuit breaker function and at least one ground electrode function. The at least one ground electrode function, the isolator function and the circuit breaker function are integrated in one and the same module. A locking unit is integrated in the module. The locking unit subjects the isolator function, the circuit breaker function and the at least one ground electrode function to mutual interlocking.

### CROSS-REFERENCE TO RELATED APPLICATION

This application claims the priority, under 35 U.S.C. § 119, of German Patent Application DE 10 2023 203 692.4, filed Apr. 21, 2023; the prior application is herewith incorporated by reference in its entirety.

### FIELD AND BACKGROUND OF THE INVENTION

The invention relates to an electrical assembly having an isolator function, a circuit breaker function and at least one ground electrode function.

Such electrical assemblies are used in a known manner in medium-voltage and high-voltage electrical switchgear installations for connecting and isolating sections of electrical power supply or power distribution networks.

### SUMMARY OF THE INVENTION

It is accordingly an object of the invention to provide an electrical assembly, which overcomes the hereinafore-mentioned disadvantages of the heretofore-known assemblies of this general type and which is particularly space-saving.

With the foregoing and other objects in view there is provided, in accordance with the invention, an electrical assembly having an isolator function, a circuit breaker function and at least one ground electrode function, the at least one ground electrode function, the isolator function and the circuit breaker function being integrated in one and the same module.

Advantageous refinements of the assembly according to the invention are specified in dependent claims.

An important advantage of the assembly according to the invention can be considered that of making possible a spatially interlocking placement of the module components through the integration of the functions in a common module, as a result of which the space available within the module can be used very effectively.

Another important advantage of the assembly according to the invention can be considered that of being able to save on parts such as support elements and/or mating contacts, for example, through the use of the module solution in some module components because their function can be performed by parts of adjacent components.

The module may be single-phase or multi-phase.

For each electrical phase, the module preferably has a circuit breaker which provides the circuit breaker function and has two switching contacts which are movable relative to one another, are in contact with one another in the switched-on state of the circuit breaker and are spaced apart from one another along a main axis in the switched-off state, a first fixed terminal contact which is electrically connected to one of the two switching contacts, and a second fixed terminal contact which is electrically connected to the other of the two switching contacts.

For each electrical phase, the module preferably has an isolator blade which provides the isolator function and can be pivoted about an isolator pivot axis.

For each electrical phase, the module preferably has a first ground electrode blade which provides a first ground electrode function and can be pivoted about a first ground electrode pivot axis.

For each electrical phase, the module preferably has a second ground electrode blade which provides a second ground electrode function and can be pivoted about a second ground electrode pivot axis.

It is advantageous if the isolator pivot axis passes through the first terminal contact of the circuit breaker and is held mechanically thereby.

It is also advantageous if the remote blade end of the first ground electrode blade in its ground electrode position makes direct contact with the second terminal contact of the circuit breaker by touching it.

The remote blade end of the second ground electrode blade in its ground electrode position preferably makes contact with a fixed isolator contact by touching it, wherein the isolator blade also makes contact with the fixed isolator contact in a closed position of the isolator blade by touching it.

The remote blade end of the first ground electrode blade in its ground electrode position, the remote blade end of the second ground electrode blade in its ground electrode position, and the first and second terminal contacts of the circuit breaker preferably lie in the same connection plane.

The isolator pivot axis and/or the main axis preferably also lie in the connection plane.

The isolator pivot axis and the main axis preferably span a main plane.

The main plane and the connection plane are preferably at least parallel or, more preferably, even form the same plane.

The remote blade end of the first ground electrode blade in its ground electrode position, the remote blade end of the second ground electrode blade in its ground electrode position, and the first and second terminal contacts of the circuit breaker preferably lie on the main axis.

A ground electrode pivot axis plane spanned by the first ground electrode pivot axis and the second ground electrode pivot axis and the main plane spanned by the isolator pivot axis and the main axis are preferably parallel planes spaced apart from one another.

The ground electrode pivot axis plane and the connection plane, in which the remote blade end of the first ground electrode blade in its ground electrode position, the remote blade end of the second ground electrode blade in its ground electrode position, and the first and second terminal contacts of the circuit breaker lie, are preferably parallel.

The module preferably has a carrier frame.

The ground electrode pivot axes, ground electrode drives for driving the ground electrode blades, a pivot drive for driving the isolator blade, and the circuit breaker are preferably held by the carrier frame.

The carrier frame spans a frame plane in which the ground electrode pivot axes preferably lie.

The frame plane is preferably parallel to a main plane which is spanned by the isolator pivot axis and the main axis.

The frame plane is preferably parallel to a connection plane, in which the remote blade end of the first ground electrode blade in its ground electrode position, the remote blade end of the second ground electrode blade in its ground electrode position, and the first and second terminal contacts of the circuit breaker lie.

It is advantageous if a locking unit, which subjects the isolator function, the circuit breaker function and at least one ground electrode function to mutual interlocking, is integrated in the module.

This is preferably a specific solution for the generator switch, that is to say a high-current application with, for example, up to 6700 A at 24 kV (shutdown capacity 72 kV).

Other features which are considered as characteristic for the invention are set forth in the appended claims.

Although the invention is illustrated and described herein as embodied in an electrical assembly, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective view of an exemplary embodiment of an assembly according to the invention; and

FIG. 2 is an elevational view of another assembly according to the invention.

### DETAILED DESCRIPTION OF THE INVENTION

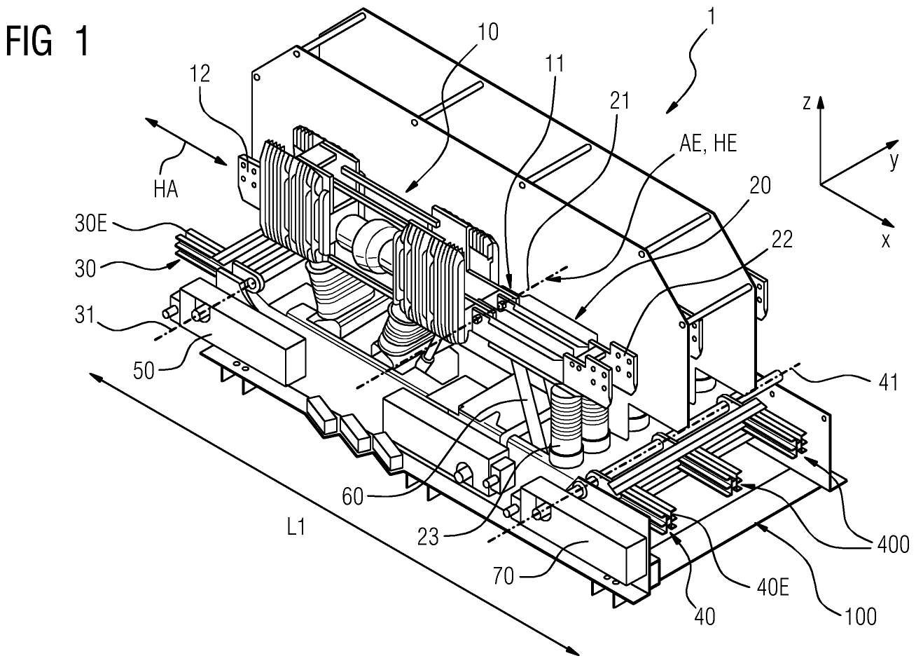

Referring now to the figures of the drawings in detail and first, particularly, to FIG. 1 thereof, there is seen an exemplary embodiment of an assembly according to the invention, in which two ground electrode functions, an isolator function and a circuit breaker function are integrated in a single compact module 1.

The module 1 according to FIG. 1 is three-phase, with the following explanations referring, for example, to only one of the phases of the module 1, namely the one in the foreground of FIG. 1. These explanations, however, apply correspondingly to the other two phases, of which only ground electrode blades 400 are clearly visible.

The module 1 includes a circuit breaker 10 having two switching contacts which are movable relative to one another, are in contact with one another in the switched-on state of the circuit breaker 10 and are spaced apart from one another along a main axis HA in the switched-off state. The two movable switching contacts are located in a housing and are covered thereby in the view according to FIG. 1. The main axis HA is parallel to the x coordinates.

The circuit breaker 10 has a first fixed terminal contact 11, which is electrically connected to one of the two switching contacts, and a second fixed terminal contact 12, which is electrically connected to the other of the two switching contacts.

The module 1 also includes an isolator blade 20 which can be pivoted about an isolator pivot axis 21, a first ground electrode blade 30 which can be pivoted about a first ground electrode pivot axis 31, and a second ground electrode blade 40 which can be pivoted about a second ground electrode pivot axis 41. The pivoting movements of the isolator blades take place in a pivoting plane which is parallel to the plane spanned by the x coordinates and the z coordinates in FIG. 1. The ground electrode pivot axes 31 and 41 are parallel to the y coordinates.

In order to achieve the shortest possible module length L1 of the module 1, the isolator blade 20 is neither provided with its own supporting body for supporting the isolator pivot axis 21 nor with its own mating contact for connection to the terminal contact 11. Instead, in the module 1 according to FIG. 1, provision is made for the isolator pivot axis 21 to pass directly through the first terminal contact 11 of the circuit breaker 10 and to be held mechanically thereby. The terminal contact 11 thus fulfills a dual function for the isolator blade 20, because it acts as both a support body and as a pivot axis holder.

In order to achieve the shortest possible module length L1 of the module 1, there is also no separate mating contact for the first ground electrode blade 30. Instead, provision is made for a remote blade end 30E of the first ground electrode blade 30 in its ground electrode position to make direct contact with the second terminal contact 12 of the circuit breaker 10 by touching it.

In order to achieve the shortest possible module length L1 of the module 1, there is also no separate mating contact for the second ground electrode blade 40. Instead, provision is made for a remote blade end 40E of the second ground electrode blade 40 in its ground electrode position to make contact with a fixed isolator contact 22, which is assigned to the isolator blade 20 and is supported by a support element 23, by touching it. This fixed isolator contact 22 is also contacted by the isolator blade 20 in the closed position thereof by touching it.

In the module 1 according to FIG. 1, the remote blade end 30E of the first ground electrode blade 30 in its ground electrode position, the remote blade end 40E of the second ground electrode blade 40 in its ground electrode position, and the first and second terminal contacts 11 and 12 of the circuit breaker 10 lie in the same connection plane AE, which saves installation space. The connection plane AE is parallel to the plane spanned by the x coordinate and the y coordinate in FIG. 1.

A main plane HE, which is spanned by the isolator pivot axis 21 and the main axis HA, is preferably identical to the connection plane AE with regard to optimum compactness of the module 1. In other words, the isolator pivot axis 21 and the main axis HA preferably also lie in the connection plane AE.

FIG. 1 also shows that the remote blade end 30E of the first ground electrode blade 30 in its ground electrode position, the remote blade end 40E of the second ground electrode blade 40 in its ground electrode position, and the first and second terminal contacts 11 and 12 of the circuit breaker 10 preferably lie on the main axis HA.

The module 1 according to FIG. 1 also includes a carrier frame 100, which holds or carries the ground electrode pivot axes 31 and 41, ground electrode drives 50 and 70 for driving the ground electrode blades 30 and 40, a pivot drive 60 for driving the isolator blade 20, and the circuit breaker 10. The frame plane of the carrier frame 100 and the ground electrode pivot axis plane spanned by the ground electrode pivot axes 31 and 41 located therein are parallel to both the main plane HE and the connection plane AE, which likewise achieves a compact module structure.

A locking unit, which subjects the isolator function, the circuit breaker function and the two ground functions to mutual interlocking and which is not illustrated in more detail in FIG. 1 for reasons of clarity, is preferably integrated in the module 1, which achieves a situation in which the change of the switching states can only take place in a predetermined sequence in time.

As already mentioned, the module 1 is three-phase according to FIG. 1. The structure is preferably identical for all phases and it is preferably the case that the main axes HA of all phases are parallel, the main axes HA of all phases lie in one and the same main plane HE and the ground electrode pivot axis planes of all phases are in the same frame plane of the same carrier frame 100. The pivot planes of the isolator blades are preferably all parallel to the plane spanned by the x-coordinates and the z-coordinates.

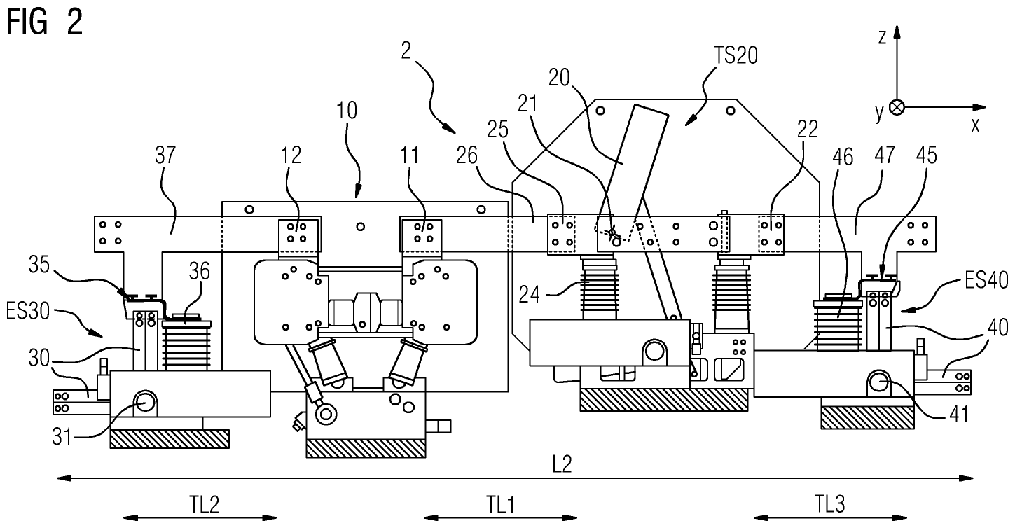

For a better understanding of the compact module structure of the module 1 according to FIG. 1, FIG. 2 shows a different assembly 2, in which the isolator function, the ground electrode function and the circuit breaker function are ensured by a circuit breaker 10, two ground electrode switches ES30 and ES40, and an isolator switch TS20. The circuit breaker 10, the two ground electrode switches ES30 and ES40, and the isolator switch TS20 are autonomous components that are independent of one another.

Since the isolator switch TS20 is an autonomous component, it has another support element 24 for supporting its own mating contact 25. The mating contact 25 must be connected via an additional connecting line 26 to the terminal contact 11 of the circuit breaker 10, which increases a module length L2 of the assembly 2 in relation to the module length L1 of the module 1 according to FIG. 1 by a partial length TL1.

Since the first ground electrode switch ES30 is an autonomous component, it also has its own mating contact 35. This mating contact 35 must be supported via a separate support element 36 and connected to the terminal contact 12 of the circuit breaker 10 via an additional connecting line 37, which further increases the module length L2 of the assembly 2 in relation to the module length L1 of the module 1 according to FIG. 1, specifically by a partial length TL2.

Since the second ground electrode switch ES40 is also an autonomous component, it also has its own mating contact 45. The mating contact 45 must be supported via a separate support element 46 and connected via an additional connecting line 47 to the fixed isolator contact 22 of the isolator switch TS20, which further increases the module length L2 of the assembly 2 in relation to the module length L1 of the module 1 according to FIG. 1, specifically by a partial length TL3.

In sum, therefore, the module length L1 of the module 1 according to FIG. 1 is substantially smaller than the total length L2 of the assembly 2 according to FIG. 2 because, in the module 1 according to FIG. 1, the mating contacts 25, 35 and 47 and the connecting lines 26, 37 and 47 are saved or omitted. In FIG. 2, the saved module length results from the sum of the partial lengths TL1, TL2 and TL3.

Finally, it should be mentioned that the features of all the exemplary embodiments described above can be combined among one another in any desired way in order to form further other exemplary embodiments of the invention.

Moreover, all the features of the dependent claims can be combined in each case by themselves with any of the other claims, specifically in any desired combination with one or more features of other dependent claims in order to obtain further other exemplary embodiments.

Irrespective of the grammatical gender of a specific term, persons with male, female, or other gender identity are also included.

The following is a summary list of reference numerals and the corresponding structure used in the above description of the invention:
1 Module
2 Assembly
10 Circuit breaker
11 Terminal contact
12 Terminal contact
20 Isolator blade
21 Isolator pivot axis
22 Isolator contact
23 Support element
24 Support element
25 Mating contact
26 Connecting line
30 Ground electrode blade
30E Remote blade end
31 Ground electrode pivot axis
35 Mating contact
36 Support element
37 Connecting line
40 Ground electrode blade
40E Remote blade end
41 Ground electrode pivot axis
45 Mating contact
46 Support element
47 Connecting line
50 Ground electrode drive
60 Pivot drive
70 Ground electrode drive
100 Carrier frame
400 Ground electrode blade
AE Connection plane
ES30 Ground electrode switch
ES40 Ground electrode switch
HA Main axis
He Main plane
L1 Module length
L2 Module length
TL1 Partial length
TL2 Partial length
TL3 Partial length
TS20 Isolator switch

1. An electrical assembly, comprising:
a module; and
an isolator function, a circuit breaker function and at least one ground electrode function all being integrated in said module.

2. The electrical assembly according to claim 1, which further comprises a locking unit integrated in said module, said locking unit subjecting said isolator function, said circuit breaker function and said at least one ground electrode function to mutual interlocking.

3. The electrical assembly according to claim 1, wherein said module is single-phase or multi-phase and for each electrical phase has:
a circuit breaker providing said circuit breaker function and having two switching contacts being movable relative to one another, being in contact with one another in a switched-on state of said circuit breaker and being spaced apart from one another along a main axis in a switched-off state, a first fixed terminal contact electrically connected to one of said two switching contacts, and a second fixed terminal contact electrically connected to another of said two switching contacts;
an isolator blade providing said isolator function and being pivotable about an isolator pivot axis;
a first ground electrode blade providing a first ground electrode function and being pivotable about a first ground electrode pivot axis; and
a second ground electrode blade providing a second ground electrode function and being pivotable about a second ground electrode pivot axis.

4. The electrical assembly according to claim 3, wherein said isolator pivot axis passes through said first fixed terminal contact of said circuit breaker and is held mechanically by said first fixed terminal contact.

5. The electrical assembly according to claim 3, wherein said first ground electrode blade has a remote blade end making direct contact with and touching said second terminal contact of said circuit breaker in a ground electrode position.

6. The electrical assembly according to claim 5, which further comprises a fixed isolator contact, said second ground electrode blade having a remote blade end making contact with and touching said fixed isolator contact in a ground electrode position, and said isolator blade also making contact with and touching said fixed isolator contact in a closed position of said isolator blade.

7. The electrical assembly according to claim 6, which further comprises a connection plane, said remote blade end of said first ground electrode blade in said ground electrode position, said remote blade end of said second ground electrode blade in said ground electrode position, and said first and second terminal contacts of said circuit breaker all lying in said connection plane.

8. The electrical assembly according to claim 7, wherein said isolator pivot axis lies in said connection plane.

9. The electrical assembly according to claim 8, which further comprises a main axis lying in said connection plane.

10. The electrical assembly according to claim 8, wherein said isolator pivot axis and said main axis span a main plane.

11. The electrical assembly according to claim 8, wherein said isolator pivot axis and said main axis span a main plane, and said main plane and said connector plane are parallel or form the same plane.

12. The electrical assembly according to claim 3, which further comprises a main axis, said remote blade end of said first ground electrode blade in said ground electrode position, said remote blade end of said second ground electrode blade in said ground electrode position, and said first and second terminal contacts of said circuit breaker all lying on said main axis.

13. The electrical assembly according to claim 3, wherein at least one of:
a ground electrode pivot axis plane spanned by said first ground electrode pivot axis and said second ground electrode pivot axis and a main plane spanned by said isolator pivot axis and a main axis, are parallel planes spaced apart from one another, or
said ground electrode pivot axis plane and a connection plane in which said remote blade end of said first ground electrode blade in said ground electrode position, said remote blade end of said second ground electrode blade in said ground electrode position, and said first and second terminal contacts of said circuit breaker lie, are parallel.

14. The electrical assembly according to claim 3, which further comprises:
ground electrode drives for driving said ground electrode blades; and
a pivot drive for driving said isolator blade;
said module having a carrier frame; and
said ground electrode pivot axes, said ground electrode drives for driving said ground electrode blades, said pivot drive for driving said isolator blade, and said circuit breaker being held by said carrier frame.

15. The electrical assembly according to claim 14, wherein:
said carrier frame spans a frame plane in which said ground electrode pivot axes lie; and
said frame plane is at least one of:
parallel to a main plane spanned by said isolator pivot axis and a main axis, or
parallel to a connection plane in which said remote blade end of said first ground electrode blade in said ground position, said remote blade end of said second ground electrode blade in said ground position, and said first and second terminal contacts of said circuit breaker lie.
